(19) United States
(12) Patent Application Publication
(10) Pub. No.: US 2016/0140322 A1
(43) Pub. Date: May 19, 2016

(54) System and Method for Conducting Cohort Trials

(71) Applicant: IMS Health Incorporated, Danbury, CT (US)

(72) Inventors: Piyush Menon, San Francisco, CA (US); Vladimir Dubal, San Francisco, CA (US); Anil Kapu, Dublin, CA (US); Sandeep Kulkarni, Fremont, CA (US); Amit Ranade, Fremont, CA (US); Suresh Kannan, Foster City, CA (US)

(21) Appl. No.: 14/541,460

(22) Filed: Nov. 14, 2014

(51) Int. Cl. G06F 19/00

(52) U.S. Cl. CPC G06F 19/363

(57) ABSTRACT

A computer-assisted method that includes: receiving data encoding parameters defining a study plan of a clinical trial with more than one participant clinical sites; adding a first cohort to the study plan; adding a second cohort to the study plan, the second cohort having no overlapping patient with the first cohort; subsequent to onset of the clinical trial, receiving de-identified information encoding attributes of participant human subjects at each of the clinical sites; parsing the received de-identified information to map the participant human subjects to a particular cohort of the study plan; in response to receiving update information encoding attributes of the participant human subjects at each of the clinical sites, longitudinally tracking the de-identified participant human subjects as mapped to corresponding cohorts of the study plan while the clinical trial progresses at the clinical sites; and providing analytics of the cohorts of the study plan.

### BACKGROUND

Clinical trials are conducted to validate the efficacy and uncover toxicity of a healthcare product, such as a pharmaceutical product or a medical device.

### OVERVIEW

In one aspect, some implementations provide a computer-implemented method to model a clinical trial, the method including: receiving data encoding parameters defining a study plan of the clinical trial with more than one participant clinical sites, the parameters including a total enrollment target of human subjects as well as targeted milestone dates of the study plan, the study plan including more than one cohorts, and the clinical sites having varying capabilities in administering each cohort; adding a first cohort to the study plan, the first cohort characterized by a first set of attributes commonly possessed by a first group of human subjects; specifying the first set of attributes as well as a corresponding target enrollment number of the first group of human patients to define the first cohort; adding a second cohort to the study plan, the second cohort characterized by a second set of attributes commonly possessed by a second group of human subjects, the second set of attributes different from the first set of attributes; specifying the second set of attributes as well as a corresponding target enrollment number of the second group of human patients to define the second cohort, the second group of human subjects having no overlap with the first group of human subjects; subsequent to onset of the clinical trial, receiving, from data servers at the clinical sites, information encoding attributes of participant human subjects at each of the clinical sites, the information devoid of identifier information capable of identifying an individual human subject; parsing the received information to map the participant human subjects to a particular cohort of the study plan; in response to receiving, from the data servers at the clinical sites, update information encoding attributes of the participant human subjects at each of the clinical sites, longitudinally tracking, by a processor, the participant human subjects as mapped to corresponding cohorts of the study plan as the clinical trial progresses at the clinical sites; and providing analytics of the cohorts of the study plan based on the longitudinal tracking

Implementations may include one or more of the following features. Providing analytics of the cohorts of the study plan may include: analyzing the mapped human subjects for each cohort to generate actual enrollment statistics for the cohorts at the clinical sites; and presenting the actual enrollment statistics for each cohort of the study plan.

Analyzing the mapped human subjects may further include: generating longitudinal actual enrollment statistics for each cohort from the corresponding clinical sites involved in conducting the particular cohort of the study plan during progression of the clinical trial. The method may further include: projecting enrollment statistics for each cohort of the study plan based on the generated longitudinal actual enrollment statistics from the corresponding clinical sites; and presenting the projected enrollment statistics for each cohort of the study plan. Analyzing the mapped human subjects for each cohort may further include: generating actual enrollment statistics from the clinical sites that span across more than one country and are involved in conducting the particular cohort of the study plan based on the generated longitudinal actual enrollment statistics from the clinical sites. The method may further include: aggregating the generated actual enrollment statistics from the clinical sites involved in conducting the particular cohort of the study plan in each country; and presenting the aggregated actual enrollment statistics for cohorts of the study plan on a country-by-country basis.

The method may further include: presenting a progress indication for each cohort based on the generated longitudinal actual enrollment statistics for the particular cohort as well as the targeted milestone dates for the study plan.

The method may further include: generating actual enrollment statistics from all participating cohorts at a particular clinical site; and presenting a progress indication for each participating cohort at the particular clinical site.

Providing analytics of the cohorts of the study plan may further include: generating progression statistics for each cohort of the study plan being conducted at the clinical sites of the particular cohort. Generating the progression statistics for each cohort of the study plan may include: generating summary statistics on initiating the study plan at the corresponding clinical sites for the particular cohort as measured against the targeted milestone dates of the study plan.

Generating the progression statistics for each cohort of the study plan may include: generating summary statistics on screening human subjects at the corresponding clinical sites of the particular cohort. Generating the progression statistics for each cohort of the study plan may include: generating summary statistics on enrolling human subjects at the corresponding clinical sites for the particular cohort as measured against the total enrollment target of human subjects for the study plan.

Parsing the received information may further include: extracting at least one attribute of each participant human patient; and linking each participant human subject to a particular cohort of the study plan in accordance with the extracted at least one attribute of the participant human subject. Parsing the received information may further include: conducting an Extract, Transform, and Load (ETL) operation on the received information to map participant human subjects to corresponding cohorts of the study plan. Linking each participant human subject to a particular cohort of the study plan may further include: longitudinally linking the participant human subject at least in part based on a matching unique patient identifier of the human subject that does not reveal the human subject's identity. Linking each participant human subject to a particular cohort of the study plan may further include: longitudinally linking the participant human subject as the human subject is seen at more than one clinical site during the clinical trial.

The method may further include: adding a third cohort to the study plan, the third cohort characterized by a third set of attributes commonly possessed by a third group of human subjects, the third set of attributes different from the first set and the second set of attributes. The method may additionally include: specifying the third set of attributes as well as a corresponding target enrollment number of the third group of human patients to define the third cohort, the third group of human subjects having no overlap with the first group and the second group of human subjects.

In another aspect, some implementations provide a computer system comprising one or more processors, configured to perform the operations of: receiving data encoding parameters defining a study plan of the clinical trial to be conducted at more than one clinical sites, the parameters including a total enrollment target of human subjects as well as targeted milestone dates of the study plan, the study plan includes more than one cohorts, and the clinical sites having varying capabilities in handling human subjects for each cohort; adding a first cohort to the study plan, the first cohort characterized by a first set of attributes commonly possessed by a first group of human subjects; defining the first cohort by specifying the first set of attributes as well as a corresponding target enrollment number of the first group of human patients; adding a second cohort to the study plan, the second cohort characterized by a second set of attributes commonly possessed by a second group of human subjects, the second set of attributes different from the first set of attributes; defining the second cohort by specifying the second set of attributes as well as a corresponding target enrollment number of the second group of human patients, the second group of human subjects having no overlap with the first group of human subjects; subsequent to onset of the clinical trial, receiving, from data servers at the clinical sites, information encoding attributes of participant human subjects at each of the clinical sites, the information devoid of identifier information capable of identifying an individual patient; parsing the received information to map the participant human subjects to a particular cohort of the study plan; in response to receiving update information encoding attributes of participant human subjects, longitudinally tracking the participant human subjects as mapped to corresponding cohorts of the study plan as the clinical trial progresses at the clinical sites; and providing analytics of the cohorts of the study plan based on the tracking

In yet another aspect, some implementations provide a computer-readable medium, comprising software instructions, which when executed by a processor of a computer, causes the computer to perform the operations of: receiving data encoding parameters defining a study plan of the clinical trial to be conducted at more than one clinical sites, the parameters including a total enrollment target of human subjects as well as targeted milestone dates of the study plan, the study plan includes more than one cohorts, and the clinical sites having varying capabilities in handling human subjects for each cohort; adding a first cohort to the study plan, the first cohort characterized by a first set of attributes commonly possessed by a first group of human subjects; defining the first cohort by specifying the first set of attributes as well as a corresponding target enrollment number of the first group of human patients; adding a second cohort to the study plan, the second cohort characterized by a second set of attributes commonly possessed by a second group of human subjects, the second set of attributes different from the first set of attributes; defining the second cohort by specifying the second set of attributes as well as a corresponding target enrollment number of the second group of human patients, the second group of human subjects having no overlap with the first group of human subjects; subsequent to onset of the clinical trial, receiving, from data servers at the clinical sites, information encoding attributes of participant human subjects at each of the clinical sites, the information devoid of identifier information capable of identifying an individual patient; parsing the received information to map the participant human subjects to a particular cohort of the study plan; in response to receiving update information encoding attributes of participant human subjects, longitudinally tracking the participant human subjects as mapped to corresponding cohorts of the study plan as the clinical trial progresses at the clinical sites; and providing analytics of the cohorts of the study plan based on the tracking

The details of one or more aspects of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1A illustrates an example system for deriving data analytics for a clinical trial based on data of human subjects from participant clinical sites.

FIG. 1B illustrates an example system for collecting data of human subjects from data servers at participant clinical sites of a clinical trial and longitudinally tracking the human subjects during the course of the clinical trial.

FIG. 1C illustrates an example linkage of daily reported data for the participant human subjects based on matching anonymized tags.

FIG. 2A is a flow chart showing an example process flow in some implementations.

FIG. 2B-2D are flow charts showing various aspects of the example process flow in some implementations.

FIG. 3A shows an example user interface to edit a study plan on a data server.

FIG. 3B shows another example user interface to edit a study plan.

FIG. 4A shows an example user interface to add and map cohorts of a clinical trial according to some implementations.

FIG. 4B shows an example user interface to define individual cohorts.

FIG. 4C shows an example user interface to map cohorts to sites.

FIGS. 4D-4E show example user interfaces to exclude cohorts from sites and to map cohorts to sites as input into a projection algorithm in some implementations.

FIGS. 4F shows example user interfaces for deselecting cohorts that will not be enrolled by the sites.

FIG. 5A shows an example user interface for aggregating data from multiple countries and visualizing them on a country-by-country basis.

FIGS. 5B-5E show example user interfaces for displaying actual enrollment statistics from cohorts world-wide and with breakdowns for each country, each component cohort.

FIG. 5F show example user interfaces to track cohort and non-cohort trials.

Like reference symbols in the various drawings indicate like elements.

### DETAILED DESCRIPTION

This disclosure generally describes a system and method for providing data analytics from cohort trials including multiple cohort groups of human subjects participating in clinical trial. Each cohort group of human subjects are linked based on comparable characteristics and are followed over time. Each cohort group may be exposed to a particular stimulus variable, such as a particular pharmaceutical product at a given dose range. The cohort trial study may include multiple cohort groups. These groups may be distributed to various facilities during the trial. To facilitate management of the trial study being conducted, human patient data may be gathered at each facility and then reported to a central facility, for example, on a daily basis. When the human patient data is gathered at each facility, such data is de-identified to maintain confidentiality. In other words, the de-identified data is void of information capable of identifying the actual patient or human subject. After such de-identified data is reported to a central facility, the de-identified data for a particular human patient can be longitudinally tracked. In other words, de-identified data for the same patient or human subject may be linked to generate longitudinal data over time. Thereafter, statistical ensemble analysis may be conducted to reveal summary data regarding patient enrollment at each participating facility, patient enrollment for each cohort group, as well as projection enrollment analysis. The ensemble analysis may track de-identified patients as they move from one facility to another. The ensemble analysis may reveal trend in patient recruitment or drop-out at a particular facility. The ensemble analysis may also aggregate patient data for a particular cohort group distributed among various facilities. The ensemble analysis may provide real-time patient enrollment status for a particular cohort group at each country. The projection analysis may factor in historical performance at a particular facilities, for a study of a particular disease. The projection analysis may generate statistical confidence indication for inter-group comparisons. The projection analysis may also indicate estimated time to completion for a particular comparison, for example, between two cohort groups.

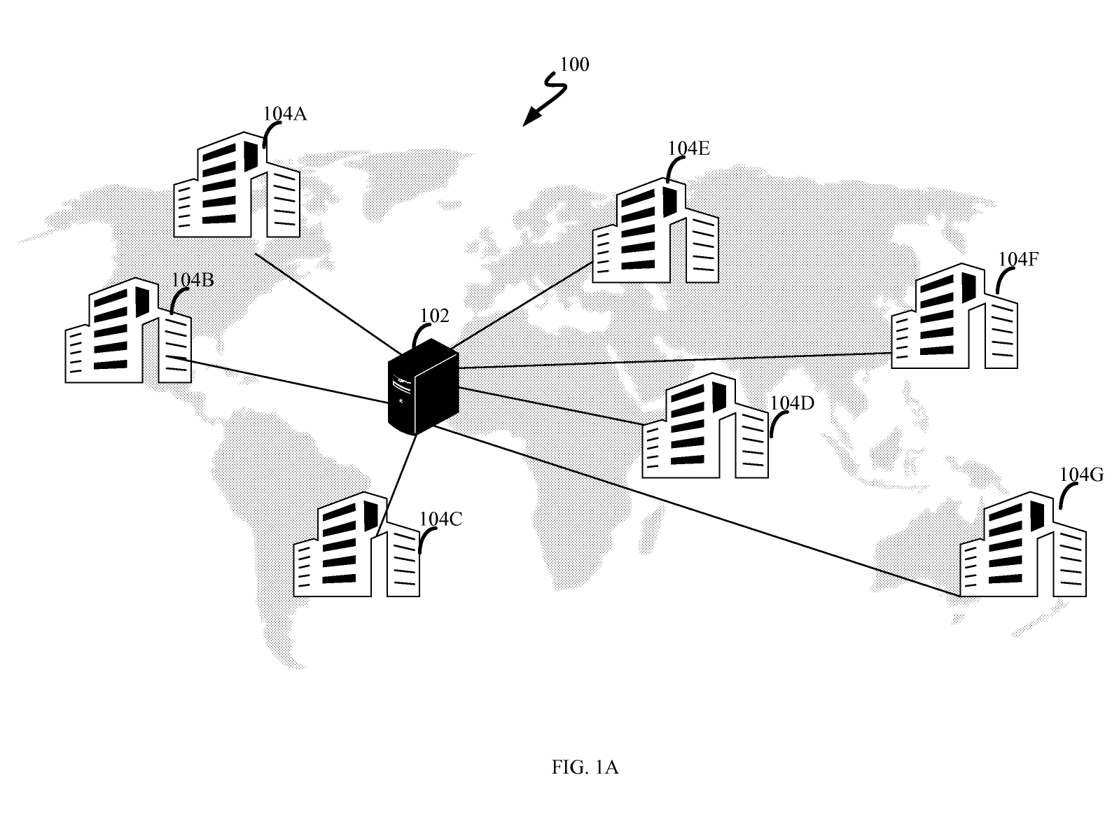

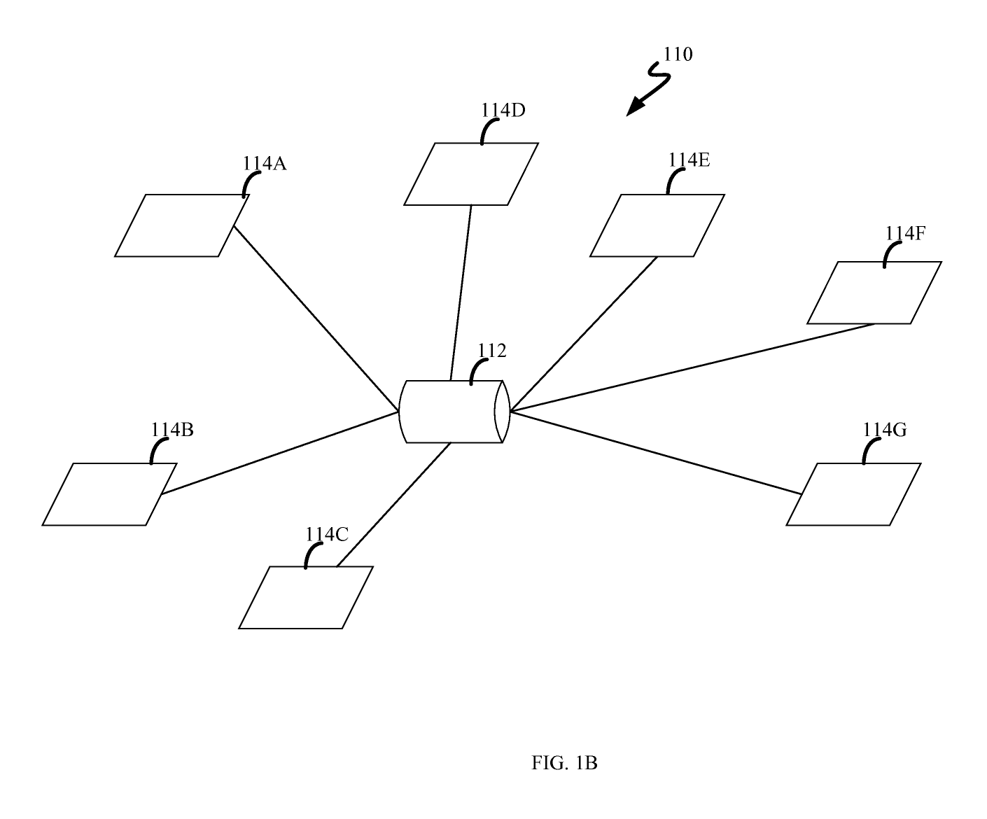

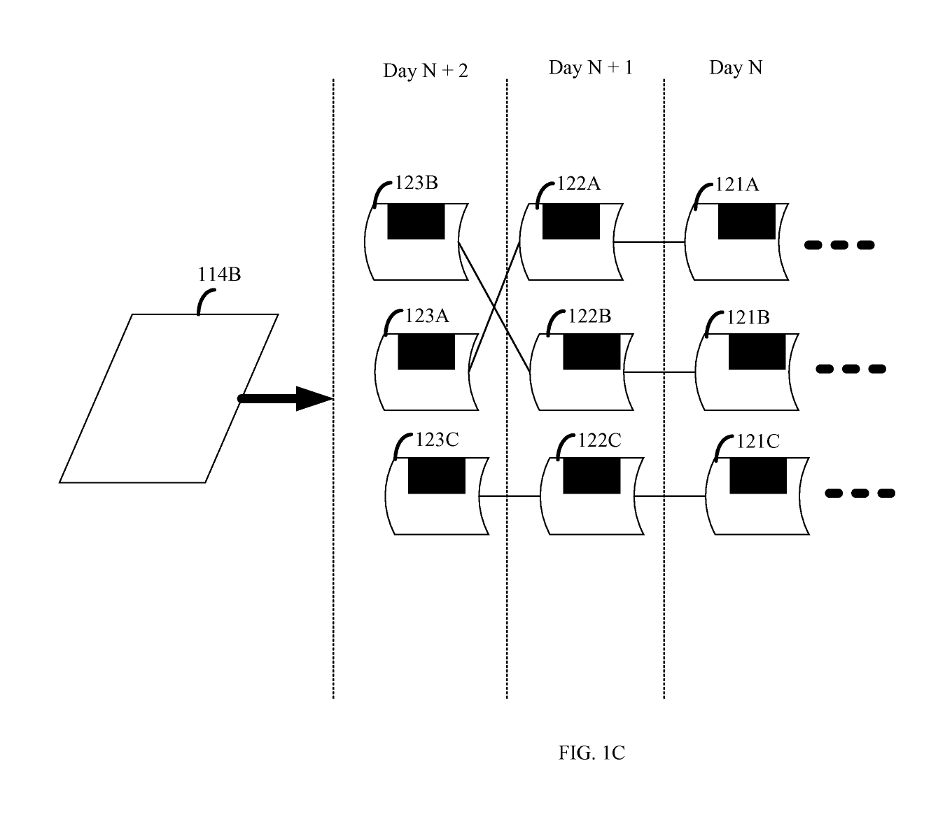

FIG. 1A illustrates an example system 100 for deriving data analytics for a clinical trial based on data of human subjects from participant clinical sites. The clinical trial may test the efficacy and toxicity of a pharmaceutical product, such as a drug, a medical device, for approval process by a regulatory agency, such as the Federal Drug Administration (FDA), the European Medicines Agency (EMA), the Medicines and Healthcare products Regulatory Agency (MHRA), In an earlier phase of the clinical trial, the pharmaceutical product may be tested in a smaller group of people (e.g., volunteers) to test its safety, determine safe dosage range, and identify side effects. In later phases, the pharmaceutical product may be tested in a larger group of people, including patients, to test efficacy and further evaluate safety, compare to reference pharmaceutical product or a placebo. The clinical trial may be conducted at multiple sites 104A to 104G, such as hospitals, clinics, long-term care facilities. These sites can cover a geographic region, for example, a region in the US. These sites may also be located globally, for example, the North American continent, the European Union. The clinical trial may be conducted synchronously across all participant sites. The clinical trial may enroll participant patients at each participating site and record biomarker data of each participant patient during the progression of the trial. In some cases, enrolled patients may drop out voluntarily or due to illness, disqualification. Yet, for larger trials, to provide sufficient statistical confidence to distinguish various groups in in statistical analysis such as t-test or the analysis of variance (ANOVA), the patient pool in each group needs to be maintained at a certain size. When patient drop-out occurs, there may be a need to further recruit patient to maintain pool size. In some cases, patient drop-out may be predicted based on heuristic evidence, for example, past record of patient drop-out at the site for a similar study.

Data for each participant patient may be recorded at a participating site. The data may include regular measurement data including, for example, urine sample data, blood sample data, blood pressure data, respiratory data, or heart rate data. The data may be electronic. For example, blood sample data may include blood glucose level, triglyceride level, low-density lipoprotein (LDL) level, high-density lipoprotein (HDL) level. In some instances, such electronic data may correspond to lab results from a contracting diagnostic laboratory, such as a contracting research organization (CRO). The lab results may not be limited to chemical analysis results. The lab results may also include image analysis results based on, for example, diagnostic images.

Data for each participant patient, as recorded at the participant site, is de-identified such that the data does not include information capable of identifying the particular participant patient. Examples of such identifying information include: patient's name, patient's insurance identification number, patient's Medicare/Medicaid identification number, patient's social security number, patient driver's license number, etc. In some implementations, such identifying information may be converted by a one-way hash-function to generate an alpha-numerical string. The alpha-numerical string conceals the identity of the individual participant patient, thereby maintaining confidentiality of the data as the data is being reported, for example, daily from the sites 104A to 104G to the central server 102. There, data corresponding to the same participant patient may be linked by virtue of the matching alpha-numerical string. Thus, data for the same participant patient may be longitudinally tracked as the clinical trial unfolds, without compromising confidentiality of the individual patients.

FIG. 1B illustrates an example work flow 110 for collecting data of human subjects from data servers at participant clinical sites of a clinical trial and longitudinally tracking the human subjects during the course of the clinical trial. Data 114A-114G may correspond to data reported from each participant site. In some implementations, data 114-114G may be reported from data servers at each participant site on a daily basis, for example, at the end of business data local time. Data 114A-114G remain de-identified to preserve confidentiality, as disclosed herein. In this illustrated work flow, each participant site may employ the same one-way hashing function to anonymize data records of each patient. As a result, reported data 114A-114G, as received at central server 102 to update database 112, include the same de-anonymized key for records from the same patient, even if the patient may move to another facility. The central server 102 may match data records from the same patient to update database 112, which contains data records reported earlier for the same patient in this cohort trial study.

In some implementations, however, the de-identified data may be further encrypted before the data is reported to central server 102 to update database 112. For illustration, data 114A-114G may be encrypted using a symmetric encryption key specific to each participant site. The symmetric encryption key may only be known to the particular participant site and central server 102. Thus, only the participant site can encrypt the de-identified data with the symmetric key and only the central server 102 can decrypt the encrypted de-identified data with the particular symmetric key. In another illustration, a public-key infrastructure (PKI) may be used such that the reported data may be encrypted with the public key of the central server 102 so that only the central server 102 can decrypt using its private key. In other illustrations, the central server 102 and participant sites 104A-104G may exchange messages using the PKI to establish an agreed-on symmetric key.

FIG. 1C illustrates an example linkage of daily reported data for the participant human subjects based on matching anonymized tags. As illustrated, the daily received data (for example, data 114B from participant site 104B) correspond to participant patients. The de-identification process allows such data to remain anonymous. In some implementations, the de-identified data from the same patient may be linked at central server 102. As illustrated, data are received on different days for the participant patients. For example, on day N, de-identified data 121A to 121C may be received. Likewise, on day N+1, de-identified data 122A to 122C are received. Similarly, on day N+2, de-identified data 123A to 123C may be received. These de-identified data correspond to different participant patients. By virtue of matching tags, such as matching de-identified alpha-numerical strings, the de-identified data from each participant patients may be linked and hence longitudinally tracked. In some implementations, the matching tags may include graphic representations as well as alpha-numerical strings. The graphic representations are also de-identified to remove personally identifiable information of the participant patient. In some instances, the alpha-numerical strings or graphical representations may be tags to the actual data record, which may be referred to as part of the metadata. In other instances, the alpha-numerical strings or graphical representations may be embedded to the actual data record itself In still other instances, the alpha-numerical strings or graphical representations may be part of the metadata and embedded in the actual data record. The implementations of both the tag and the embedding may further deter alterations or modifications of the data records being reported from each participant site. When the received daily data records are linked with earlier data records of the same participant human patients, database 112 may be updated. The updated database may allow a variety of data analytics to be generated, revealing the summary statistics of the on-going cohort trial study.

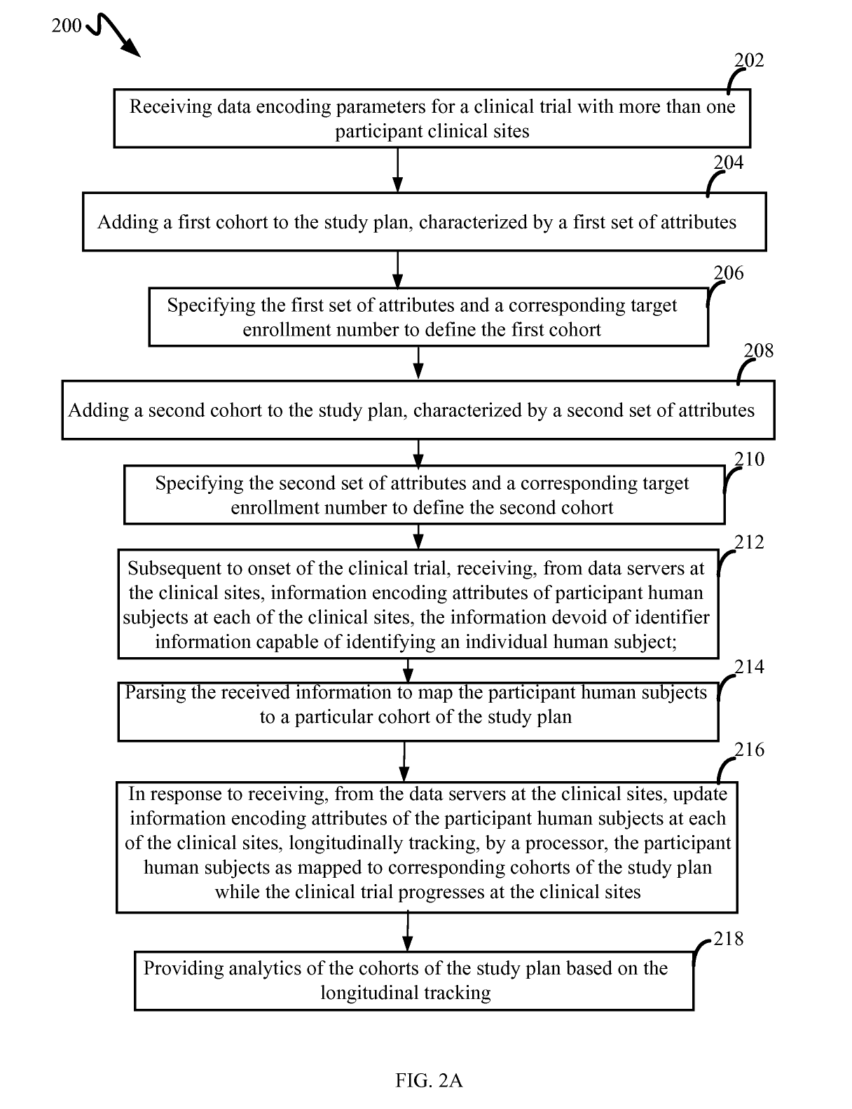

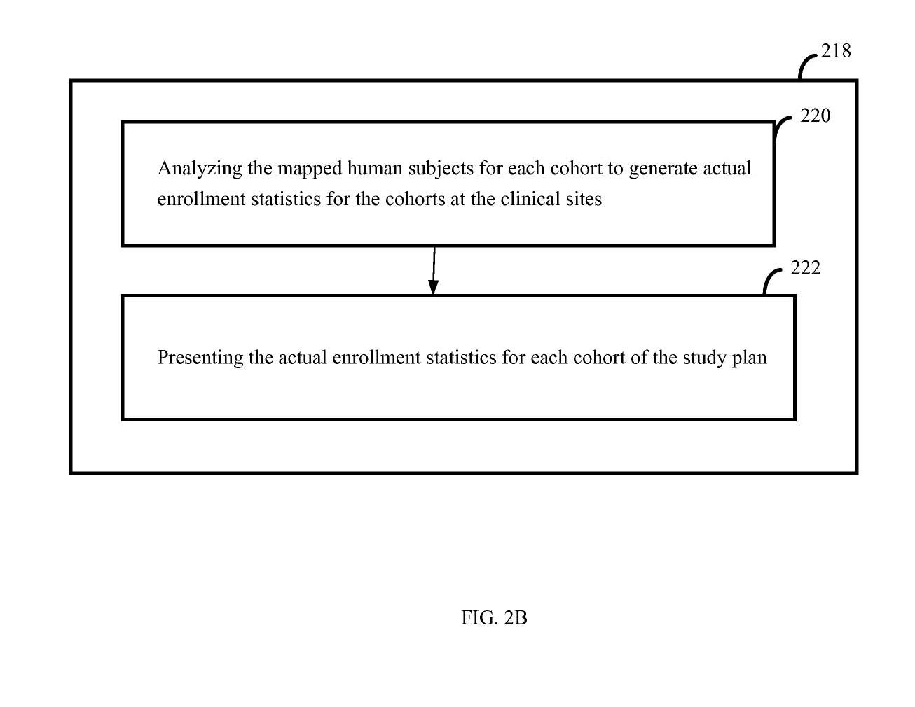

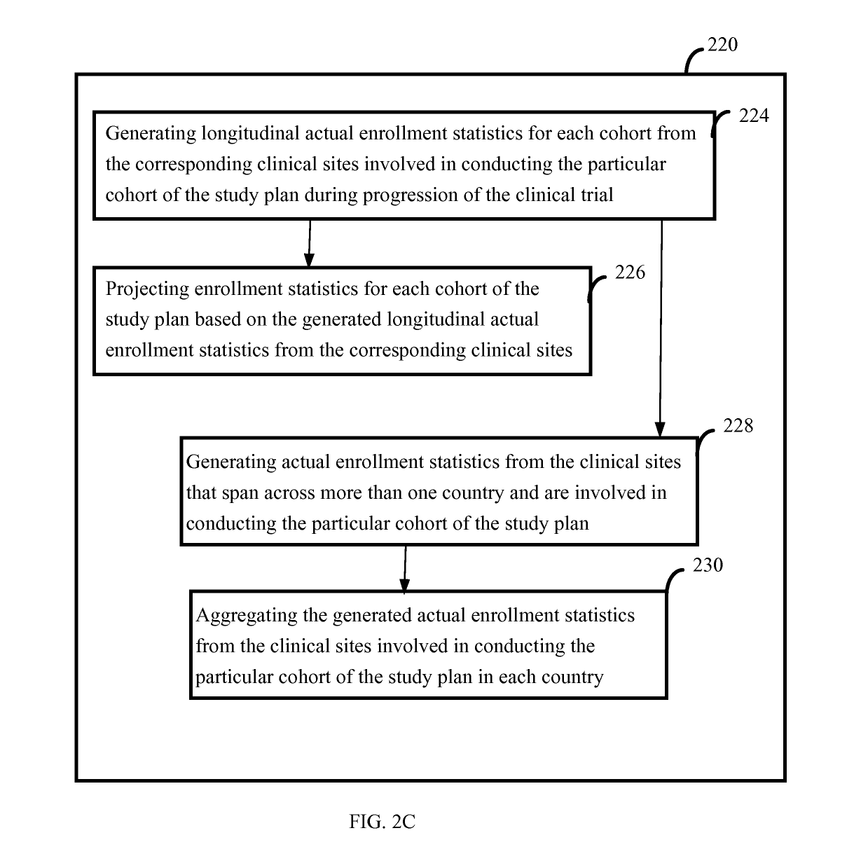

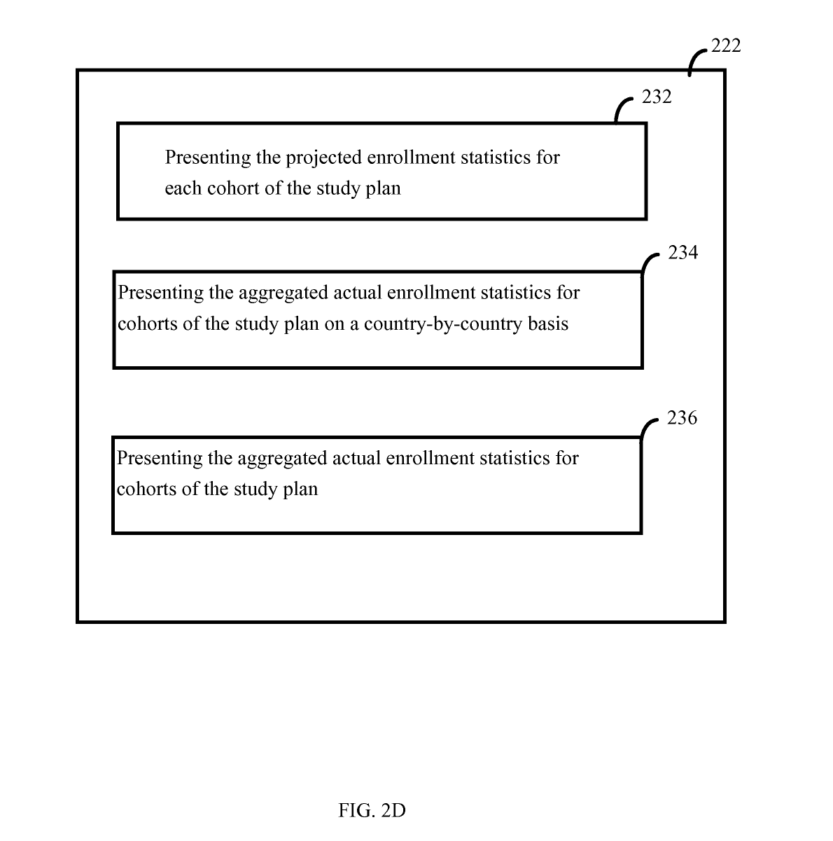

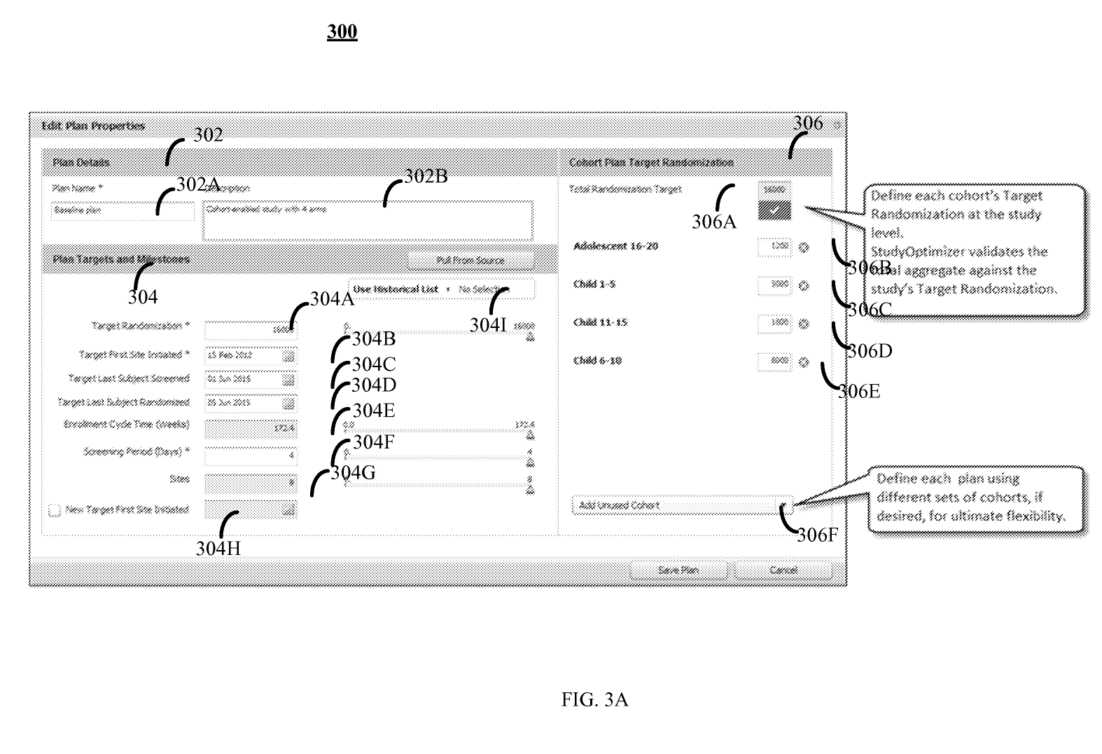

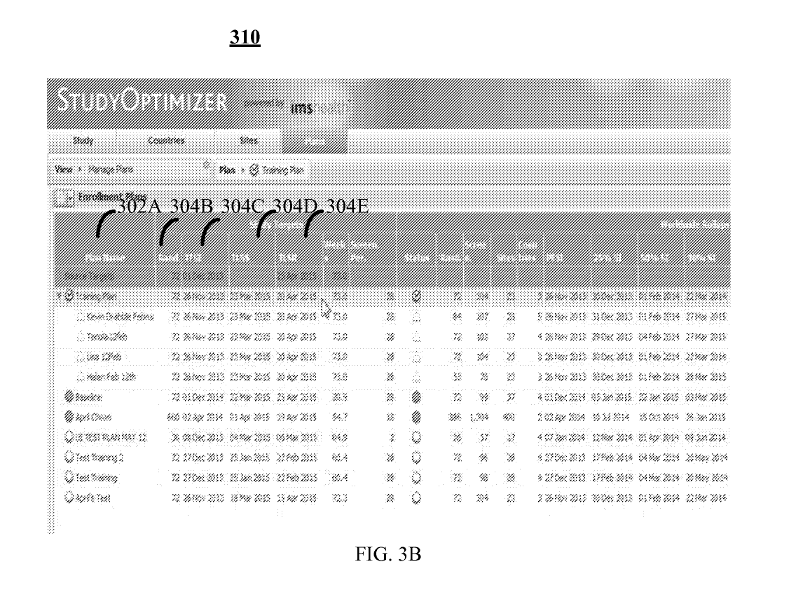

FIG. 2A is a flow chart 200 showing an example process flow for generating such data analytics in some implementations. Initially, data is received at a data server, such as central server 112. The data encodes parameters for a clinical trial with more than one participant sites (202). Such parameters may include plan name, plan description, plan targets and milestones, cohorts target enrollment (also known as randomization) for each cohort. As illustrated in FIG. 3A, an user-interface 300 may be provided to receive user input on plan details 302, plan targets and milestones 304, and cohort plan target randomization 306. Plan details 302 may include plan name 302A and description 302B. Plan targets and milestones 304 may include target randomization 304A, target first site initiated (TFSI) 304B, target last subject screened (TLSS) 304C, target last subject randomized (TLSR) 304D, enrollment cycle time 304E, screening period 304F, sites 304G. Here, randomization refers to patient recruitment. Plan targets and milestones 304 may additionally provide an option to add new target first site initiated (TFSI) 304H, and an option to use historical list 304I. Regarding TFSI 304H, if the start date of a study has been delayed after a plan has already been created, then it is now possible to shift all country plans automatically by changing the start date for a study. This minimizes any planning re-work that needs to be done in the event of a study delay. Cohort plans target randomization 306 may include total randomization target 306A, as well as randomization targets 306B-306E for each component cohort group. The total randomization target 306A is the aggregated target at the study level and the user interface 300 may validate the aggregated target randomization against the study's target randomization 304A. The user interface 300 may additionally provide an option to add new (unused cohort) 308. This option allows each plan to be defined with different sets of cohorts. Referring to FIG. 3B, user interface 310 provides a summary tabulation of component cohorts for each study. The tabulation interface 310 may include plan name as defined in 302A, randomization target as defined in 304A, target first site initiated (TFSI) as defined in 304B, target last subject screened (TLSS) as defined in 304C, target last subject randomized (TLSR) as defined in 304D. Each row may correspond to a particular study, such as baseline study and April Chron. Each study may include component cohorts, collapsed and indented under each study row, such as the cohort adjustment row.

Returning to FIG. 2A, the process proceeds to adding a first cohort to the study plan, the first cohort being characterized by a first set of attributes (204). In adding the first cohort, the process may specify the first set of attributes (206). As a clinical trial study including multiple cohorts, the process then proceeds adding a second cohort to the study plan, the second cohort being characterized by a second set of attributes (208). In adding the second cohort, the process may specify the second set of attributes (210).

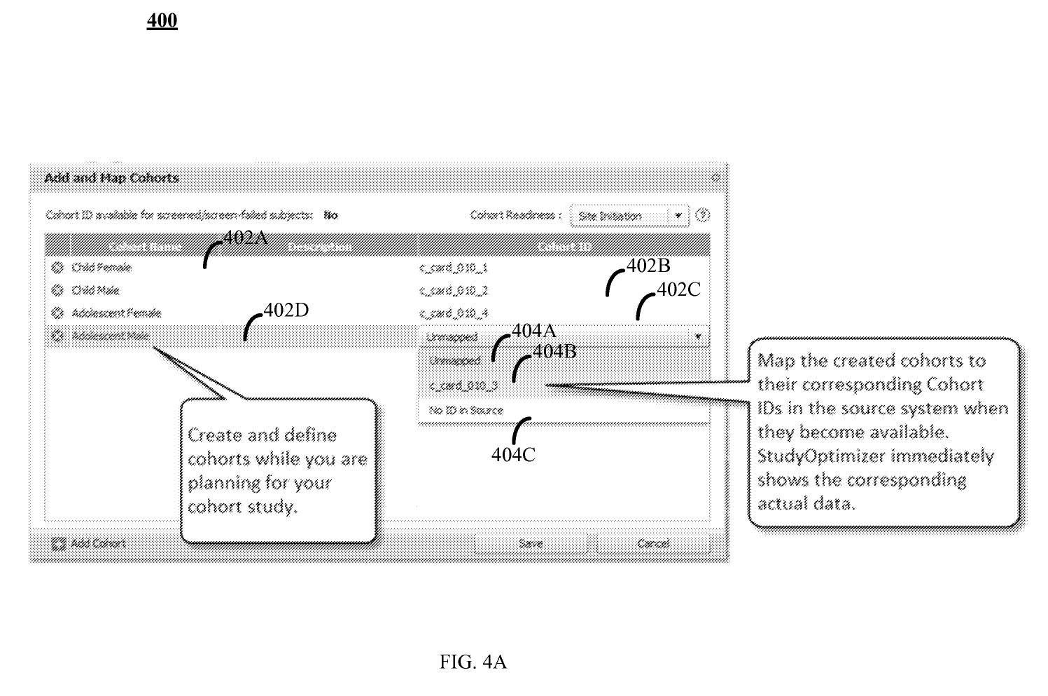

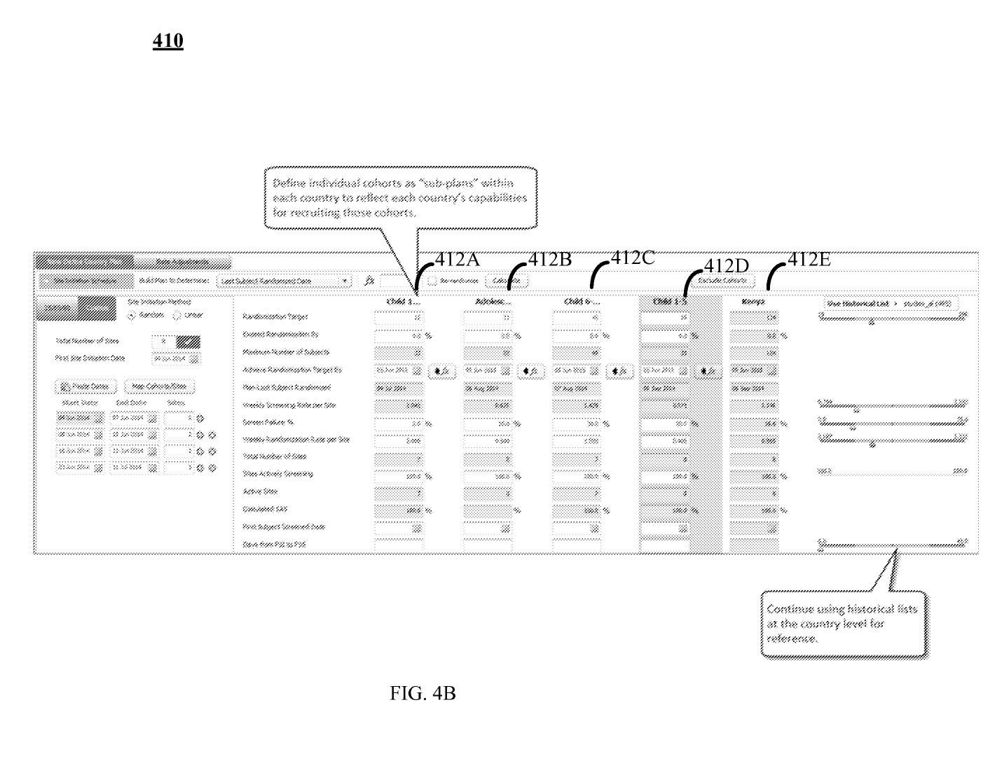

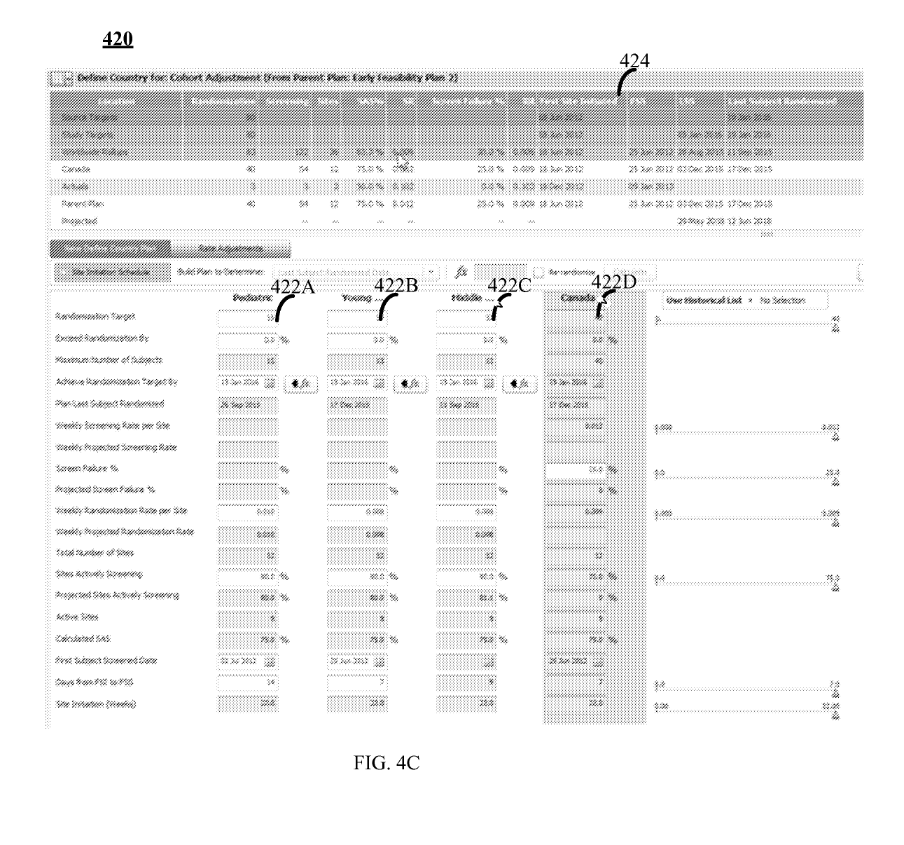

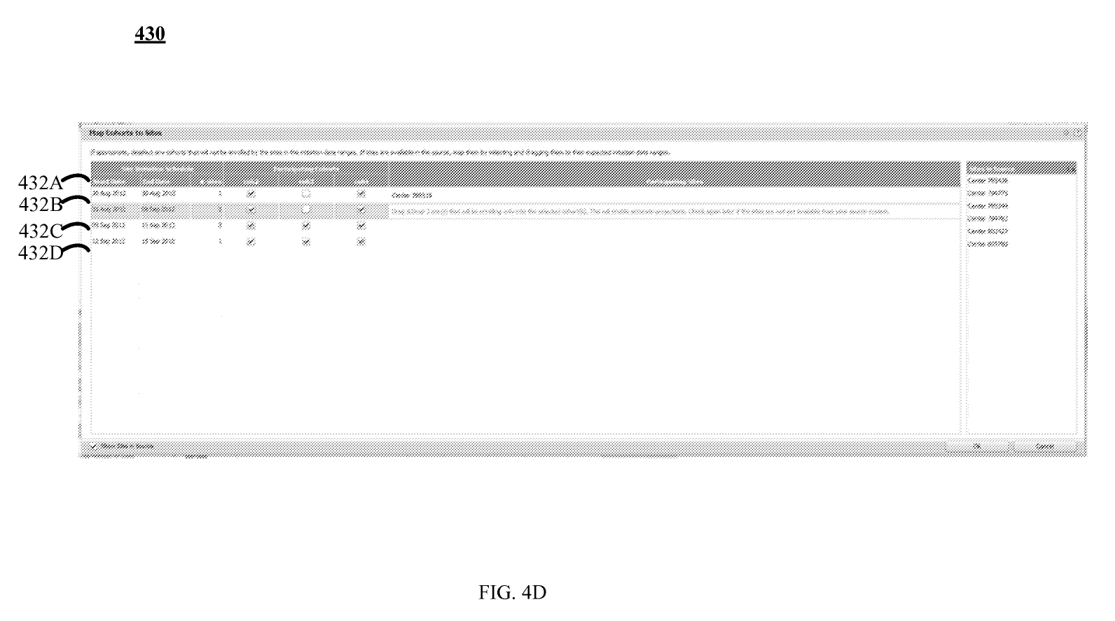

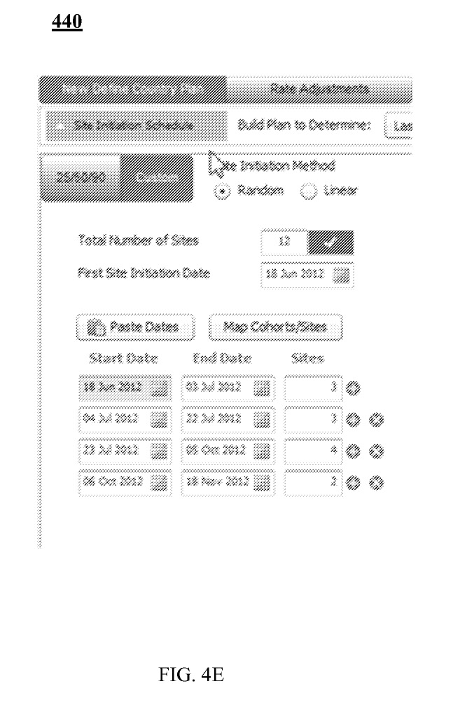

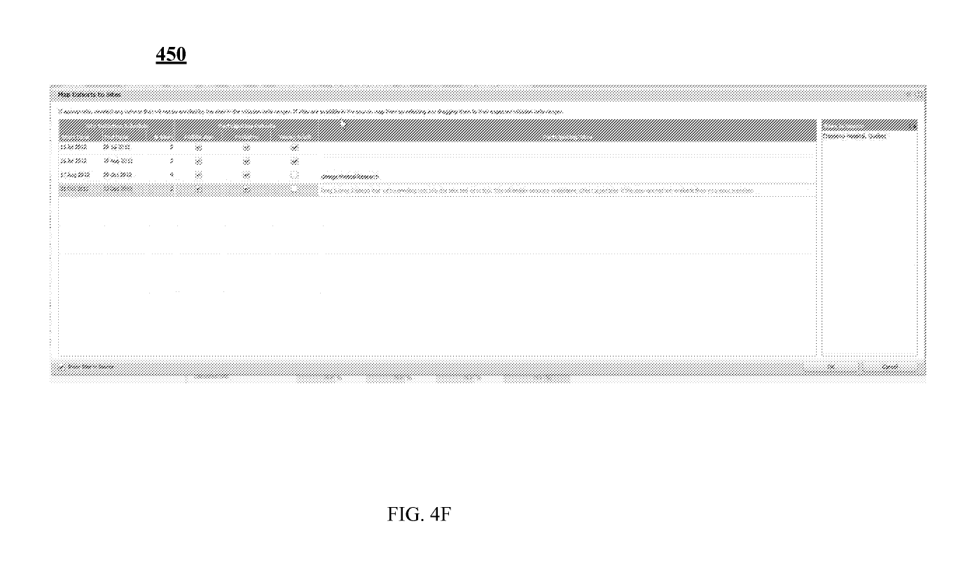

Referring to FIG. 4A, user interface 400 may allow a user to add and map cohorts to a trial study. As illustrated, four cohorts are being added to a trial study, namely, child female 402A, child male 402B, adolescent female 402C, and cohort 402D. Each cohort may be created and mapped a corresponding cohort ID, for example, cohort IDs 404A to 404C, as illustrated.

FIG. 4B shows an example interface 410 to define various aspects of cohorts of a trial study. For example, the individual cohorts may be defined as “sub-plans” within each country to reflect each country's capabilities in patient recruitment capabilities. The example user interface 410 shows four cohort groups, 412A to 412D, within one country 412E. Each cohort may include the following attributes: randomization target, exceed randomization by a configurable amount, maximum number of subjects to be enrolled (as the randomization process), date by which to achieve randomization target, planned last subject randomization date, weekly screening rate per site, screening failure rate, weekly randomization rate per site, total number of sites, sites actively screening, active sites, calculated Sites Actively Screening (SAS) percentage, first subject screened date, and days from first subject initiated to first subject screened. In particular SAS is the percentage of (Sites that have screened at least one subject)/(Sites that have initiated). In addition, user interface 410 may further include a display of historical data for reference. For example, the historical number of randomization targets for a particular group may be displayed to provide a reference as to where the current randomization target is relatively to the distribution of historical data.

FIG. 4C shows an example user interface 420 to define country for cohort adjustment. The example is based on early feasibility plan 2, as illustrated in FIG. 3B. User interface 420 shows three cohorts, pediatric 422A, Young patients 422B, middle-age group 422C, all within country 422D, which is Canada. Each cohort in country 422D may include the following attributes: randomization target, exceed randomization by a configurable amount, maximum number of subjects to be enrolled (as the randomization process), date by which to achieve randomization target, planned last subject randomization date, weekly screening rate per site, screening failure rate, weekly randomization rate per site, total number of sites, sites actively screening, active sites, calculated SAS percentage, first subject screened date, and days from first subject initiated to first subject screened. In addition, user interface 420 may further include a display of historical data for reference. For example, the historical number of randomization targets for a particular group may be displayed to provide a reference as to where the current randomization target is relatively to the distribution of historical data. What is more, a table 424 may be displayed to show the summary comparison of the combined cohorts in Canada with world-wide roll-ups. The comparison may further include actual data, projected data, and parent plan. Here, a user starts out by creating a plan or several plans. Then the user approves a plan. Then based on this plan a user can create one or more adjustments to the plan. In this case the original plan is consider the “Parent Plan”. Then a user approves an adjustment. The approved adjustment now becomes the currently “Approved Plan”. Then an adjustment can be created to the currently “Approved plan”, whereas the “Approved Plan” is now the parent plan, etc.

FIG. 4D shows user interface 430 to map each cohorts to sites. Here, each cohort may span a multitude of sites. Each site may participate in more than one cohort. Some sites may participate in only one study, due to patient recruitment restrictions. User interface 430 shows the mapping of four sites, namely 432A to 432D, to three cohorts, namely cohorts 1 to cohorts 3. In some instances, this mapping may be automatic, once each cohorts have been defined and each site's recruitment capabilities have been entered.

FIG. 4E shows user interface 440 to enable cohorts to be excluded from sites. The user interface 440 also allows cohorts to be mapped to sites such that projection algorithms may be invoked to detect trend and project trial progression. The example user interface 440 is actually invoked when a user selects the button “Map Cohorts/Sites, allowing for Sites to be marked as participating/not participating in cohorts. This can be done by excluding cohort from participating in site initiation slots, but also it can be associated with names sites. This is not clear in your screenshot, however, I have provided an alternate screenshot in my email. This input is used by the projection algorithm to determine whether a site is enrolling in a cohort or not. FIG. 4F shows a subsequent user interface 450 configured to deselect cohorts that will not be enrolled by the sites in the initiation date ranges.

Returning to FIG. 2A, subsequent to onset of the clinical trial, information is received from data servers at the clinical sites, the information encoding attributes of participant human subjects at each of the clinical sites and devoid of identifier information capable of identifying an individual human subject (212). As explained above in association with FIGS. 1A-1B, such information is anonymized to preserve confidentiality of the participant human subjects. The information may be further encrypted to enhance authenticity and deter alteration/modification of the underlying patient data. The information may be received, for example, on a daily basis. After the daily data is received, the data may be parsed to map the particular human subjects to particular cohorts of the study plan (214). Each cohort may define a particular group of subjects with certain defining characteristics, distinct from other cohorts. Furthermore, central server 102 may receive update information for a particular patient in subsequent daily reports from the participating clinical sites. The update information may be linked to previously received information for this particular patient, thereby enabling longitudinal tracking (216). This longitudinal tracking allows the status of a particular participant patient to be accessed during the course of the trial study. In particular, data analytics of the cohorts of the study plan can be generated based on the longitudinal tracking (218).

As illustrated in FIG. 2B, a processor at central server 102 may be configured to analyze the mapped human subjects for each cohort of the study plan to generate actual enrollment statistics for the cohorts at the clinical sites (220). Thereafter, the actual enrollment statistics for each cohort may be presented, for example, on a display device to a user (222).

Referring to FIG. 2C, analyzing the mapped human subjects may include generating longitudinal actual enrollment statistics for each cohort from the corresponding clinical sites involved in conducting the particular cohort of the study plan during progression of the clinical trial (224). For example, the longitudinal actual enrollment statistics may include daily enrollment statistics. The longitudinal enrollments statistics reflect new patient recruitment, patient drop-out due to screening failure, voluntary leaving, or involuntary decease. The longitudinal actual enrollment statistics from the corresponding clinical sites may then be further analyzed to project enrollment statistics for each cohort of the study plan (226).

The longitudinal actual enrollment statistics from the corresponding clinical sites may also be received from multiple sites involved in one cohort that span more than one country (228). Thereafter, the actual enrollment statistics data for the particular cohort may be aggregated at the country level to reveal actual enrollment statistics from a particular country in real-time (230). The country-specific actual enrollment statistics may be further aggregated to reveal enrollment statistics at the regional level, such as the continent level.

As illustrated in FIG. 2D, the projected enrollment statistics from 226 may be presented at a display device for a user to visualize such projected enrollment statistics for each cohort of the study plan (232). The aggregated actual enrollment statistics for cohorts of the study may be presented at the display device for the user to visualize such aggregated actual enrollment statistics at a country-by-country basis (234). Furthermore, the aggregated actual enrollment statistics for cohorts of the study plan may be presented at the display device for the user to visualize as well (236).

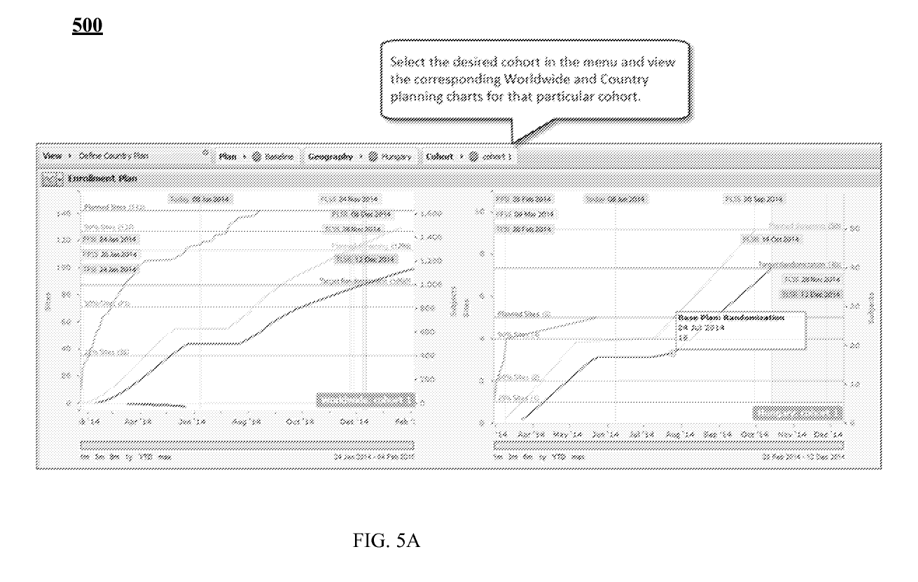

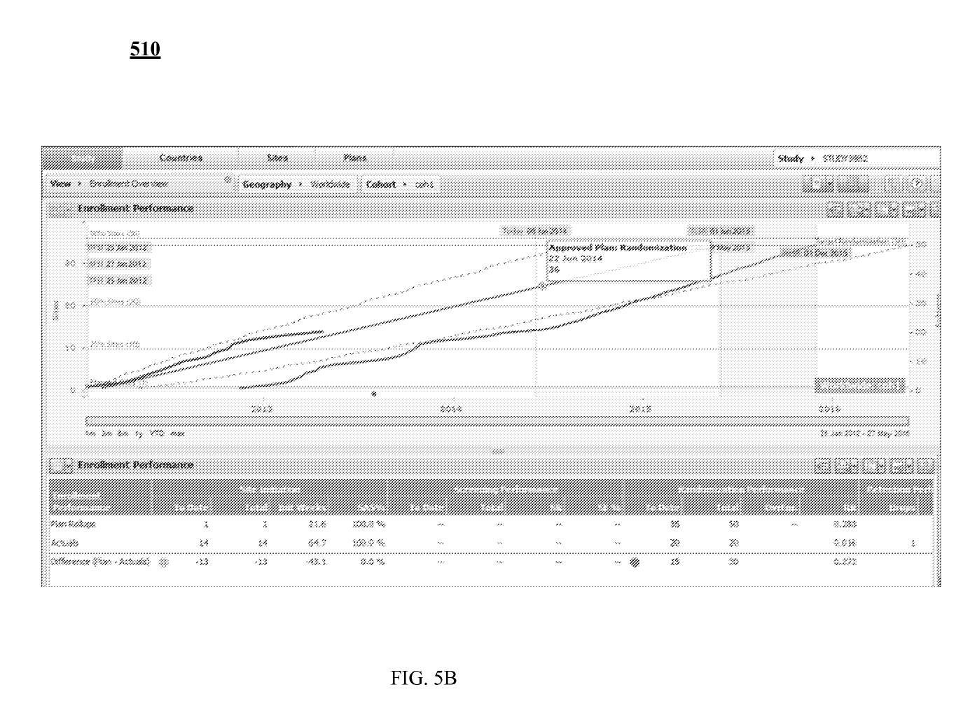

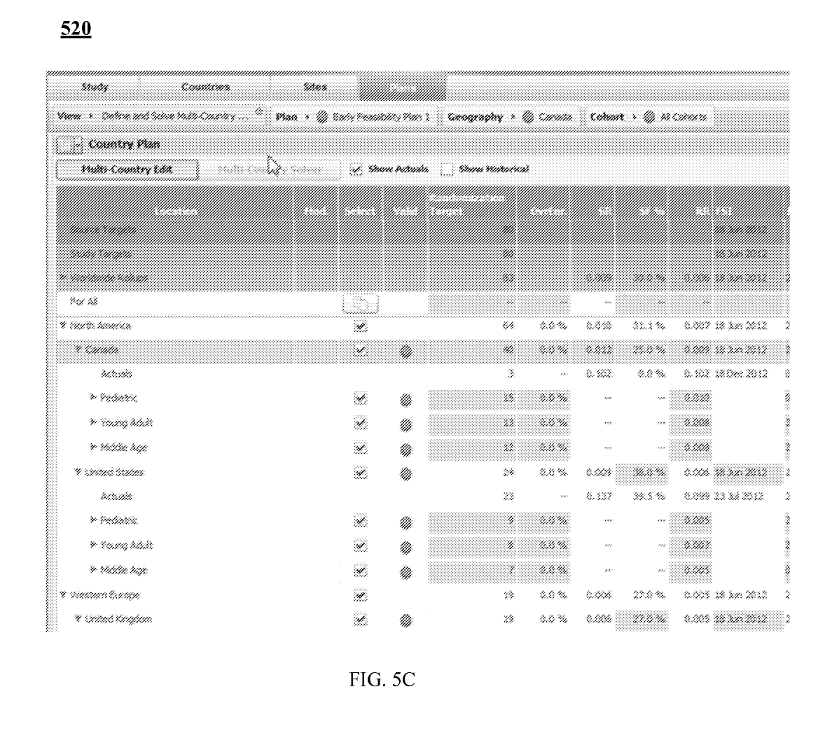

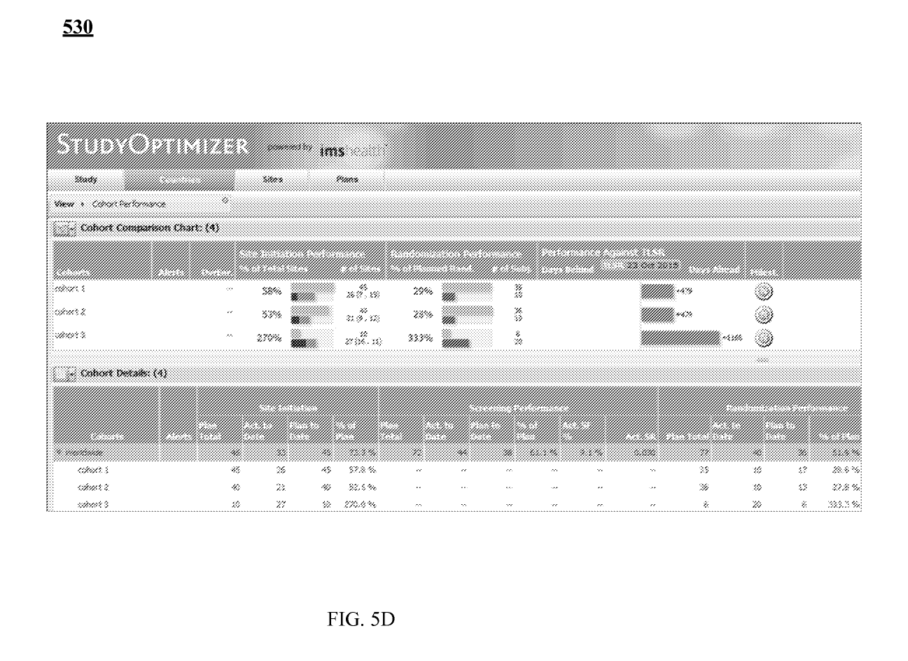

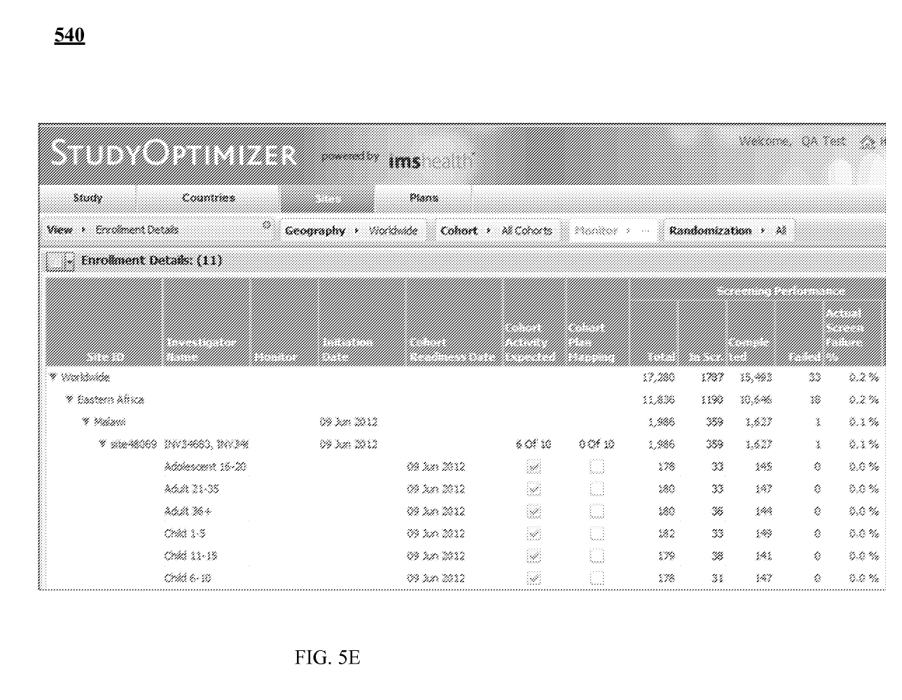

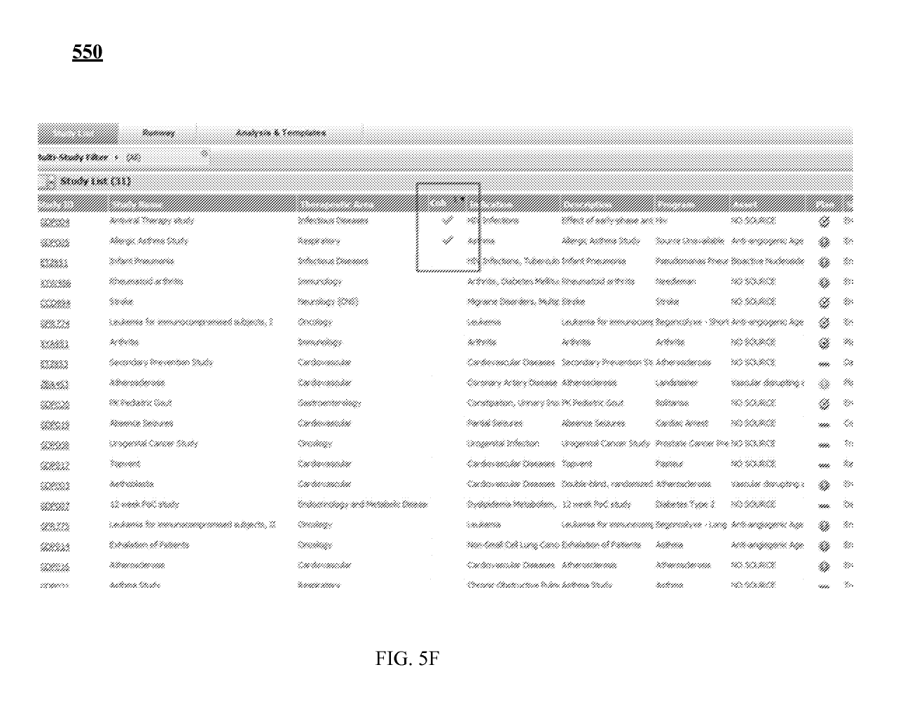

FIG. 5A show an example user interface 500 for aggregating data from multiple countries and visualizing them on a country-by-country basis. The curves represent: Site Initiation; Screening; Randomization; Screen-failure; and Dropouts. The dropdown allows to either see the individual cohort curves or to aggregate the curves across cohorts in a country. In some instances, Cohort country curves; Cohort region curves; Cohort study curves; Country Curves; Region Curves; and Study Curves are displayed. The left panel shows the aggregated actual enrollment statistics for cohort 1 from all participating countries since study initiation. The actual enrollment statistics include randomization count, date for first site initiated as compared to TFSI (as defined in 304B), date for last subject screened as compared to TLSS (as defined in 304C), date last subject randomized as compared to TLSR (as defined in 304D). The right panel shows the aggregated actual enrollment statistics for cohort 1 from Hungary as a participating country since study initiation. The actual enrollment statistics include randomization count, date for first site initiated as compared to TFSI (as defined in 304B), date for last subject screened as compared to TLSS (as defined in 304C), date last subject randomized as compared to TLSR (as defined in 304D).

FIG. 5B shows an example user interface 510 for displaying actual enrollment statistics from cohort 1 world-wide. In addition to the real-time curves, user interface 510 also includes a bottom panel to reflect summary statistics highlighting, for example, the difference between plan rollups and the actual statistics. FIG. 5C shows an example user interface 520 for displaying the breakdown of the enrollment statistics for each country, and within each country, for each group. FIG. 5D shows another example user interface 530 for displaying the progress bars for each cohort on various aspects of the study plan, for example, site initiation performance, randomization performance, and performance against TLSR (as defined in 304D). User interface 530 also displays actual enrollment statistics on these various aspects in a companion panel. FIG. 5E shows yet another example user interface displaying enrollment details worldwide for each region (e.g., eastern Africa), each country (e.g., each participating country in East Africa), each site within a particular country, and each cohort at the particular site. The user interface 540 may include a drill-down menu allowing display of the various levels at which enrollment statistics are generated.

Some implementations may provide backward compatibility for visualizing data reported from facilities without capabilities in handling cohorts as well as data from facilities capable of handling such cohorts. FIG. 5F shows an example user interface 550 to track cohort and non-cohort trials in a single database. This example user interface 550 a variety of trials being tracked in a number of therapeutic areas including infectious disease, respiratory, immunology, neurology, oncology, cardiovascular, endocrinology and metabolic disease. As illustrated, only two of these studies are cohort studies.

Some implementations disclosed herein allow participant patient data from a particular cohort group that involves multiple participant sites to be tracked in real-time. Some implementations disclosed herein allow participant patient data from multiple cohort groups at one given particular site to be tracked in real-time. Some implementations disclosed herein allow trending analysis based on the tracked data. Some implementations may blend trending analysis with historical performance at comparable time points in a study to project estimated time to completion or predict needs for further recruitment, to cope with, for example, patient drop-out or screening failure.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method to model a clinical trial, the method comprising:
receiving data encoding parameters defining a study plan of the clinical trial with more than one participant clinical sites, the parameters including a total enrollment target of human subjects as well as targeted milestone dates of the study plan, the study plan including more than one cohorts, and the clinical sites having varying capabilities in administering each cohort;
adding a first cohort to the study plan, the first cohort characterized by a first set of attributes commonly possessed by a first group of human subjects;
specifying the first set of attributes as well as a corresponding target enrollment number of the first group of human patients to define the first cohort;
adding a second cohort to the study plan, the second cohort characterized by a second set of attributes commonly possessed by a second group of human subjects, the second set of attributes different from the first set of attributes;
specifying the second set of attributes as well as a corresponding target enrollment number of the second group of human patients to define the second cohort, the second group of human subjects having no overlap with the first group of human subjects;
subsequent to onset of the clinical trial, receiving, from data servers at the clinical sites, information encoding attributes of participant human subjects at each of the clinical sites, the information devoid of identifier information capable of identifying an individual human subject;
parsing the received information to map the participant human subjects to a particular cohort of the study plan;
in response to receiving, from the data servers at the clinical sites, update information encoding attributes of the participant human subjects at each of the clinical sites, longitudinally tracking, by a processor, the participant human subjects as mapped to corresponding cohorts of the study plan as the clinical trial progresses at the clinical sites; and
providing analytics of the cohorts of the study plan based on the longitudinal tracking.

2. The method of claim 1, wherein providing analytics of the cohorts of the study plan comprises:
analyzing the mapped human subjects for each cohort to generate actual enrollment statistics for the cohorts at the clinical sites;
presenting the actual enrollment statistics for each cohort of the study plan.

3. The method of claim 2, wherein analyzing the mapped human subjects further comprises:
generating longitudinal actual enrollment statistics for each cohort from the corresponding clinical sites involved in conducting the particular cohort of the study plan during progression of the clinical trial.

4. The method of claim 3, further comprising:
projecting enrollment statistics for each cohort of the study plan based on the generated longitudinal actual enrollment statistics from the corresponding clinical sites; and
presenting the projected enrollment statistics for each cohort of the study plan.

5. The method of claim 4, wherein analyzing the mapped human subjects for each cohort further comprises:
generating actual enrollment statistics from the clinical sites that span across more than one country and are involved in conducting the particular cohort of the study plan based on the generated longitudinal actual enrollment statistics from the clinical sites.

6. The method of claim 5, further comprising:
aggregating the generated actual enrollment statistics from the clinical sites involved in conducting the particular cohort of the study plan in each country; and
presenting the aggregated actual enrollment statistics for cohorts of the study plan on a country-by-country basis.

7. The method of claim 3, further comprising:
presenting a progress indication for each cohort based on the generated longitudinal actual enrollment statistics for the particular cohort as well as the targeted milestone dates for the study plan.

8. The method of claim 2, further comprising:
generating actual enrollment statistics from all participating cohorts at a particular clinical site;
presenting a progress indication for each participating cohort at the particular clinical site.

9. The method of claim 1, wherein providing analytics of the cohorts of the study plan further comprises:
generating progression statistics for each cohort of the study plan being conducted at the clinical sites of the particular cohort.

10. The method of claim 9, wherein generating the progression statistics for each cohort of the study plan comprises:
generating summary statistics on initiating the study plan at the corresponding clinical sites for the particular cohort as measured against the targeted milestone dates of the study plan.

11. The method of claim 9, wherein generating the progression statistics for each cohort of the study plan comprises:
generating summary statistics on screening human subjects at the corresponding clinical sites of the particular cohort.

12. The method of claim 9, wherein generating the progression statistics for each cohort of the study plan comprises:
generating summary statistics on enrolling human subjects at the corresponding clinical sites for the particular cohort as measured against the total enrollment target of human subjects for the study plan.

13. The method of claim 1, wherein parsing the received information further comprises:
extracting at least one attribute of each participant human patient; and
linking each participant human subject to a particular cohort of the study plan in accordance with the extracted at least one attribute of the participant human subject.

14. The method of claim 13, wherein parsing the received information further comprises:
conducting an Extract, Transform, and Load (ETL) operation on the received information to map participant human subjects to corresponding cohorts of the study plan.

15. The method of claim 14, wherein linking each participant human subject to a particular cohort of the study plan further comprises:
longitudinally linking the participant human subject at least in part based on a matching unique patient identifier of the human subject that does not reveal the human subject's identity.

16. The method of claim 15, wherein linking each participant human subject to a particular cohort of the study plan further comprises:
longitudinally linking the participant human subject as the human subject is seen at more than one clinical site during the clinical trial.

17. The method of claim 1, further comprising:
adding a third cohort to the study plan, the third cohort characterized by a third set of attributes commonly possessed by a third group of human subjects, the third set of attributes different from the first set and the second set of attributes.

18. The method of claim 17, further comprising:
specifying the third set of attributes as well as a corresponding target enrollment number of the third group of human patients to define the third cohort, the third group of human subjects having no overlap with the first group and the second group of human subjects.

19. A computer system comprising one or more processors, configured to perform the operations of:
receiving data encoding parameters defining a study plan of the clinical trial to be conducted at more than one clinical sites, the parameters including a total enrollment target of human subjects as well as targeted milestone dates of the study plan, the study plan includes more than one cohorts, and the clinical sites having varying capabilities in handling human subjects for each cohort;
adding a first cohort to the study plan, the first cohort characterized by a first set of attributes commonly possessed by a first group of human subjects;
defining the first cohort by specifying the first set of attributes as well as a corresponding target enrollment number of the first group of human patients;
adding a second cohort to the study plan, the second cohort characterized by a second set of attributes commonly possessed by a second group of human subjects, the second set of attributes different from the first set of attributes;
defining the second cohort by specifying the second set of attributes as well as a corresponding target enrollment number of the second group of human patients, the second group of human subjects having no overlap with the first group of human subjects;
subsequent to onset of the clinical trial, receiving, from data servers at the clinical sites, information encoding attributes of participant human subjects at each of the clinical sites, the information devoid of identifier information capable of identifying an individual patient;
parsing the received information to map the participant human subjects to a particular cohort of the study plan;
in response to receiving update information encoding attributes of participant human subjects, longitudinally tracking the participant human subjects as mapped to corresponding cohorts of the study plan as the clinical trial progresses at the clinical sites; and
providing analytics of the cohorts of the study plan based on the tracking.

20. A computer-readable medium, comprising software instructions, which when executed by a processor of a computer, causes the computer to perform the operations of:
receiving data encoding parameters defining a study plan of the clinical trial to be conducted at more than one clinical sites, the parameters including a total enrollment target of human subjects as well as targeted milestone dates of the study plan, the study plan includes more than one cohorts, and the clinical sites having varying capabilities in handling human subjects for each cohort;
adding a first cohort to the study plan, the first cohort characterized by a first set of attributes commonly possessed by a first group of human subjects;
defining the first cohort by specifying the first set of attributes as well as a corresponding target enrollment number of the first group of human patients;
adding a second cohort to the study plan, the second cohort characterized by a second set of attributes commonly possessed by a second group of human subjects, the second set of attributes different from the first set of attributes;
defining the second cohort by specifying the second set of attributes as well as a corresponding target enrollment number of the second group of human patients, the second group of human subjects having no overlap with the first group of human subjects;
subsequent to onset of the clinical trial, receiving, from data servers at the clinical sites, information encoding attributes of participant human subjects at each of the clinical sites, the information devoid of identifier information capable of identifying an individual patient;
parsing the received information to map the participant human subjects to a particular cohort of the study plan;
in response to receiving update information encoding attributes of participant human subjects, longitudinally tracking the participant human subjects as mapped to corresponding cohorts of the study plan as the clinical trial progresses at the clinical sites; and
providing analytics of the cohorts of the study plan based on the tracking.
